(19) United States
(12) Patent Application Publication
(10) Pub. No.: US 2010/0097276 A1
(43) Pub. Date: Apr. 22, 2010

(54) HOUSING, METHOD OF MAKING THE HOUSING, AND ELECTRONIC DEVICE USING THE HOUSING

(75) Inventors: HE-XIAN LIN, Shenzhen City (CN); GANG HUANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/561,360

(22) Filed: Sep. 17, 2009

(30) Foreign Application Priority Data
Oct. 20, 2008 (CN) 200810305009.8

(51) Int. Cl. H01Q 1/24; B32B 3/10; B29C 39/00; B44C 1/22

(52) U.S. Cl. 343/702; 428/195.1; 264/132; 216/13

(57) ABSTRACT

A housing for electronic device includes a substrate, the substrate be formed by a integration of a metal member and a plastic member, the metal member and the plastic member cooperatively forming an outer surface of the substrate; and an decorative coating formed on the outer surface. A method for making the housing and a electronic device using the housing are provided.

### BACKGROUND

1. Technical Field

The present disclosure relates to housings, to a electronic device using the housing, and to a method of making the housing.

2. Description of Related Art

Housings for electronic devices such as mobile phones are usually made by plastic or metal. Metal housings have a better mechanical strength, but are electrically conductive, which may weaken the communication signals. Plastic housings are nonconductive, but lack mechanical strength. Some housings have plastic member(s) and metallic member(s) assembled together as a whole to achieve both good communication and mechanical strength. However, the assembly of two different types of members is time consuming and may be difficult to present a consistent appearance even if subjected to surface treatment(s).

Therefore, there is room for improvement within the art.

### BRIEF DESCRIPTION OF THE DRAWINGS

Many aspects of the housing and the method for making the housing can be better understood with reference to the following drawing. The components in the drawing are not necessarily to scale, the emphasis instead being placed upon clearly illustrating the principles of the present housing. Moreover, in the drawing, like reference numerals designate corresponding parts throughout the following view.

FIG. 1 is a cross-section view of an exemplary embodiment of the present housing.

FIG. 2 is a cross-section view of an exemplary electronic device having an antenna using the present housing.

### DETAILED DESCRIPTION OF THE EXEMPLARY EMBODIMENT

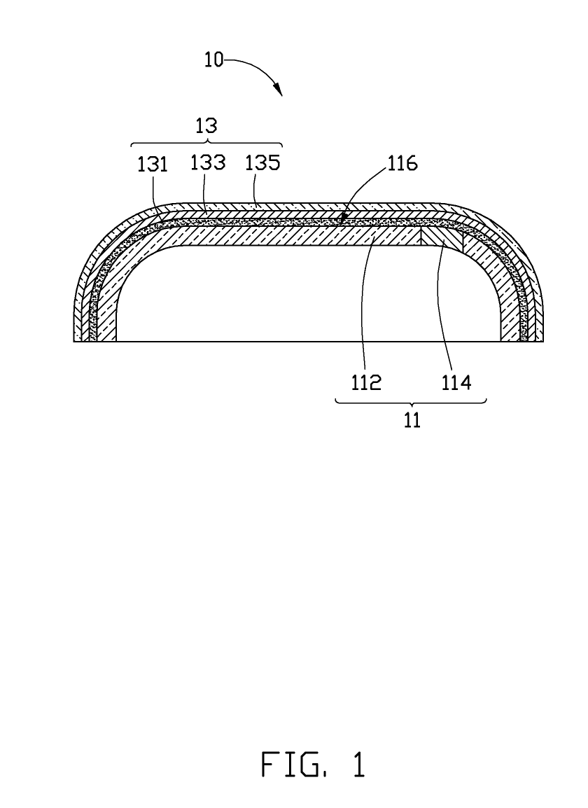

Referring to the FIG. 1, an exemplary housing 10 is used for electronic devices such as, mobile phones, laptop computers, cameras, or game consoles. The housing 10 includes a substrate 11 and a decorative coating 13.

The substrate 11 is formed by integrating a metal member 112 and a plastic member 114. The outer surface of the metal member 112 is flush with the outer surface of the plastic member 114 to cooperatively form an outer surface 116 of the substrate 11. The outer surface 116 may further have rough area(s) on one of the metal member 112 and the plastic member 114 to acquire an appearance of different brightness on the same housing 10.

The decorative coating 13 includes a base paint layer 131, a nonconductive vacuum coated layer 133, and a protective paint layer 135.

The base paint layer 131 is directly formed and envelops the whole outer surface 116 of the substrate 11. The base paint layer 131 can improve the smoothness of the outer surface 116, accordingly, improving the brightness and adhesion force of the nonconductive vacuum coated layer 133.

The nonconductive vacuum coated layer 133 is formed on the base paint layer 131. The nonconductive vacuum coated layer 133 can be made of metallic material or nonmetallic material that has a metallic appearance. The nonconductive vacuum coated layer 133 may further be partially etched to define a pattern to acquire a decorative pattern on the housing 10.

The protective paint layer 135 is formed on the surface of the nonconductive vacuum coated layer 133 by e.g., painting or brushing. The protective paint layer 135 may be made of transparent paint.

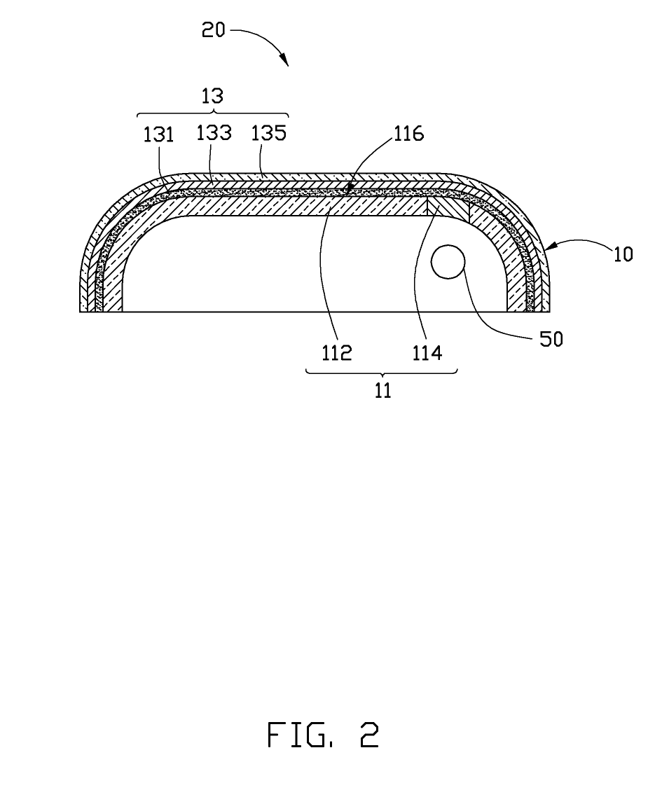

Referring to the FIG. 2, the housing 10 can be used for an electronic device such as a mobile phone 20 having an antenna 50 (schematically shown). The mobile phone 20 includes the housing 10 and the antenna 50. The plastic member 114 may be aligned above the antenna 50 received inside the housing 10 to ensure an effective telecommunication of the antenna 50.

An exemplary method of making the housing 10 may include the following steps.

Form a substrate 11 by an insert molding method. This step is carried out by inserting a die cast or pressed metal member 112 into an injection mold, and injecting a plastic material into the injection mold to form a plastic member 114 bonding with the metal member 112 to form the substrate 11. Rough area(s) of the outer surface 116 may be formed by an injection mold surface having a corresponding rough portion. Alternatively, the rough area may be directly etched on the metal member 112.

Form a decorative coating 13 on the outer surface 116. The base paint layer 131 is painted on the outer surface 116, and the nonconductive vacuum coated layer 133 is plated on the base paint layer 131, and the protective paint layer 135 is painted on the nonconductive vacuum coated layer 133. The nonconductive vacuum coated layer 133 may further be partially etched to form a pattern thereof, for example, by laser etching.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing, comprising:
a substrate, the substrate being integrally formed by a metal member and a plastic member, the metal member and the plastic member cooperatively forming an outer surface of the substrate; and
a decorative coating formed on the outer surface.

2. The housing as claimed in claim 1, wherein the decorative coating comprises a base paint layer painted on the outer surface, a nonconductive vacuum coated layer plated on the base paint layer, and a transparent protective paint layer painted on the nonconductive vacuum coated layer.

3. The housing as claimed in claim 2, wherein the nonconductive vacuum coated layer is made of a material having a metallic appearance.

4. A method of making a housing, comprising the steps of:
forming a substrate by molding a plastic member bonding with a metal member, the metal member and the plastic member cooperatively forming an outer surface of the substrate; and
forming a decorative coating on the outer surface.

5. The method of making a housing as claimed in claim 4, wherein the metal member is formed by die-casting or by pressing.

6. The method of making a housing as claimed in claim 4, wherein the decorative coating comprises a base paint layer painted on the outer surface, a nonconductive vacuum coated layer plated on the base paint layer, and a transparent protective paint layer painted on the nonconductive vacuum coated layer.

7. The method of making a housing as claimed in claim 6, wherein the nonconductive vacuum coated layer is made of a material having a metallic appearance.

8. The method of making a housing as claimed in claim 6, further comprising partially etching the nonconductive vacuum coated layer to form a pattern thereon.

9. An electronic device, comprising:
an antenna; and
a housing receiving the antenna therein, the housing comprising:
a substrate, the substrate being integrally formed by a metal member and a plastic member, the metal member and the plastic member cooperatively forming an outer surface of the substrate, the plastic member being aligned above the antenna; and
a decorative coating formed on the outer surface.

10. The electronic device as claimed in claim 9, wherein the decorative coating comprises a base paint layer painted on the outer surface, a nonconductive vacuum coated layer plated on the base paint layer, and a transparent protective paint layer painted on the nonconductive vacuum coated layer.

11. The electronic device as claimed in claim 10, wherein the nonconductive vacuum coated layer is made of a material having a metallic appearance.
